(19) United States
(12) Patent Application Publication
(10) Pub. No.: US 2011/0100972 A1
(43) Pub. Date: May 5, 2011

(54) IMAGE HEATING APPARATUS

(75) Inventors: Shoichiro Ikegami, Suntou-gun (JP); Masahiko Suzumi, Numazu-shi (JP)

(73) Assignee: CANON KABUSHIKI KAISHA, Tokyo (JP)

(21) Appl. No.: 12/911,355

(22) Filed: Oct. 25, 2010

(30) Foreign Application Priority Data
Oct. 30, 2009 (JP) 2009-250167

(51) Int. Cl. H05B 1/00

(52) U.S. Cl. 219/216

(57) ABSTRACT

An image heating apparatus includes a flexible sleeve; a heater contacted to an inner circumferential surface of the sleeve; a pressing roller for forming a nip, between itself and the sleeve contacted by the heater, in which a recording material is to be heated; and a supporting member for supporting the heater, the supporting member being disposed inside the heater and having an area in which the sleeve is sandwiched between the supporting member and the pressing roller at least on an upstream side and a downstream side of a heater supporting position of the supporting member with respect to a rotational direction of the sleeve. The supporting member is provided, at its surface in the area, with a plurality of recessed portions for permitting passage of a lubricant. The recessed portions are provided only in an area in which a predetermined maximum width sheet available in the image heating apparatus is passable.

### FIELD OF THE INVENTION AND RELATED ART

The present invention relates to an image heating apparatus used in an image forming apparatus.

The image forming apparatus may include a copying machine, a laser beam printer, a facsimile machine, and a multi-function machine having a combination of functions of these machines, etc. As the image heating apparatus, a fixing device which is used in an image forming process of an electrophotographic type, an electrostatic recording type, a magnetic recording type, or the like and is configured to fix a toner image may be used. That is, the fixing device is of the type in which an unfixed toner image formed correspondingly to objective image information by using toner formed of a heat-fusing resin material is heat-fixed on a sheet surface as a permanently fixed image. As the sheet, it is possible to use a recording material such as paper, printing paper, an OHT sheet, glossy paper, a glossy film, electrofax paper or electrostatic recording paper. Here, the image heating apparatus according to the present invention includes not only the fixing device described above but also an image forming apparatus for temporarily fixing an unfixed image and an image heating apparatus for modifying an image surface property such as gloss by re-heating a recording material on which the image is carried.

As the image forming apparatus which does not supply electric power during stand-by to minimize electric energy consumption, a surf-heating type fixing device has been conventionally put into practical use. In the surf-heating type fixing device, a fixing nip is formed by nipping a high heat-conductive sleeve of resin or metal between a pressing roller and a ceramic heater supported by a heat insulating supporting member. A recording material on which an unfixed toner image is carried is introduced into the fixing nip, so that the unfixed toner image is heat-fixed. In recent years, the image forming apparatus has been required to solve various problems such as increases in print speed and rising speed, energy saving, and downsizing. For this reason, a constitution in which a thin sleeve which has high thermal conductivity and is excellent in strength is used has been put into practical use.

Further, in the surf-heating type fixing device, a lubricant such as grease has been applied in order to realize smooth relative movement between the heater and the sleeve. The lubricant may desirably be uniformly diffused between the heater surface and an inner (peripheral) surface of the sleeve but is actually liable to stagnate at upstream and downstream portions of the heater with respect to a rotational direction of the sleeve, thus causing non-uniformity thereof. The thus caused non-uniformity causes non-uniformity of heat to be applied to the recording material, thus adversely affecting the image to be fixed. Further, the lubricant does not circulate among the sleeve, the heater and the supporting member to cause an increase in sliding torque. Particularly, in a state in which the fixing device immediately after main power is turned on is not sufficiently warmed, viscosity of the lubricant is very high. For this reason, the sliding torque is increased by the lubricant remaining at the upstream and downstream portions of the heater with respect to the rotational direction of the sleeve to constitute an obstacle to the rotation of the sleeve, so that slip of the sleeve occurs.

In order to solve the problems due to the non-uniformity of the lubricant, Japanese Patent No. 3254117 has proposed a constitution in which the supporting member for supporting the heater is provided with a recess-projection shape at its surface to promote diffusion of the lubricant. Further, Japanese Laid-Open Patent Application (JP-A) 2003-229234 has proposed a constitution in which the supporting member supporting the heater is provided with a slit to improve the diffusion of the lubricant and thus a decrease in driving torque and prevention of slip are realized.

However, the recess-projection shape described in Japanese Patent No. 3254117 and the slid described in JP-A 2003-229234 cause a problem that the thin sleeve which is used in recent years is damaged. At a sleeve portion contacted to an end portion of the recording material, scraping (abrasion) and separation of a parting layer at the sleeve surface is generally problematic from the viewpoint of durability but the durability is remarkably deteriorated by the addition of the recess-projection shape or the slit. The scraping and separation of the parting layer of the sleeve are liable to occur at a position in which the end portion of the recording material passes in a width direction of the recording material perpendicular to a conveyance direction of the recording material. This is because local stress concentration and thermal load, due to the presence or absence of paper dust and the recording material, caused by conveying the recording material is increased at the position. Particularly, in the case where the recess-projection shape or the slit is employed, these shapes further increase the load on the sleeve at the position corresponding to the recording material end portion, thus accelerating the scraping and separation of the parting layer. As a result, such a problem that the durability of the sleeve cannot be maintained is caused to occur.

### SUMMARY OF THE INVENTION

A principal object of the present invention is to provide an image heating apparatus capable of alleviating a load on a surface layer of a sleeve to improve durability of the sleeve while satisfactorily diffusing a lubricant.

According to an aspect of the present invention, there is provided an image heating apparatus comprising:

a flexible sleeve;

a heater contacted to an inner circumferential surface of the sleeve;

a pressing roller for forming a nip, between itself and the sleeve contacted by the heater, in which a recording material is to be heated; and

a supporting member for supporting the heater, the supporting member being disposed inside the heater and having an area in which the sleeve is sandwiched between the supporting member and the pressing roller at least on an upstream side and a downstream side of a heater supporting position of the supporting member with respect to a rotational direction of the sleeve,

wherein the supporting member is provided, at its surface in the area, with a plurality of recessed portions for permitting passage of a lubricant, and

wherein the recessed portions are provided only in an area in which a predetermined maximum width sheet available in the image heating apparatus is passable.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic structural view of an image forming apparatus in Embodiment 1.

FIGS. 2(a), 2(b) and 2(c) are schematic structural views of a fixing device in Embodiment 1, in which FIG. 2(a) is a sectional view of the fixing device, FIG. 2(b) is a sectional view of a heater of the fixing device, and FIG. 2(c) is an exploded perspective view of the fixing device.

FIG. 3 is a sectional view of a sleeve in Embodiment 1.

FIG. 4 is a schematic view of a supporting member of a conventional fixing device.

FIG. 5 is a schematic view for illustrating a mechanism of stress concentration by a recess-projection shape.

FIG. 6 is a schematic view showing a supporting member in Embodiment 1.

FIG. 7 is a schematic view showing a supporting member in Comparative Embodiment.

FIG. 8 is a schematic view showing a supporting member in Embodiment 2.

### DESCRIPTION OF THE PREFERRED EMBODIMENTS

Hereinbelow, the present invention will be described specifically based on embodiments with reference to the drawings. However, dimensions, materials, shapes, relative arrangement, and the like of constituent elements described in the following embodiments should be understood that the scope of the present invention is not limited thereto unless otherwise specified.

### Embodiment 1

### (Image Forming Apparatus)

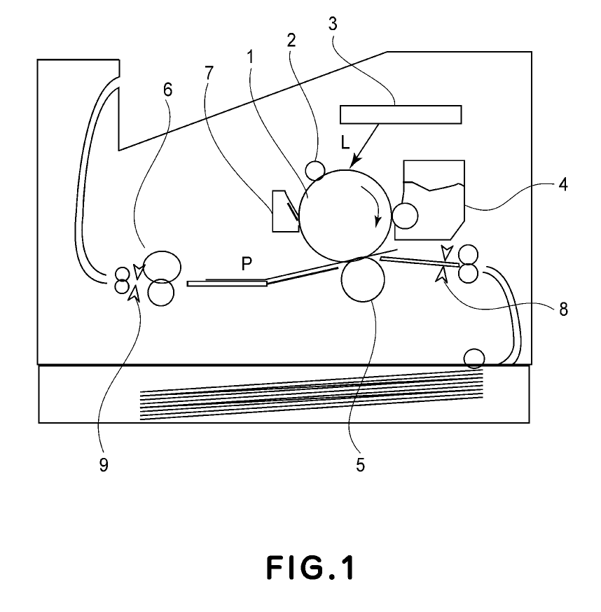

FIG. 1 shows a schematic structure of an image forming apparatus in this embodiment. A photosensitive drum 1 is prepared by forming a layer of a photosensitive material such as an organic photoconductor (OPC), amorphous selenium (Se) or amorphous silicon (Si) on a cylinder-like substrate of aluminum, nickel or the like. The photosensitive drum 1 is rotationally driven in a direction indicated by an arrow and the surface thereof is uniformly charged. Then, the surface of the photosensitive drum 1 is subjected to scanning exposure with a laser beam L, which has been ON/OFF controlled depending on image information, emitted from a laser scanner 3. As a result, an electrostatic latent image is formed on the surface of the photosensitive drum 1. This electrostatic latent image is developed and visualized into a toner image by a developing device 4. As a developing method, it is possible to use a jumping developing method, a two-component developing method, a FEED developing method, and the like. Particularly, image exposure and reverse developing are used in combination in many cases. The toner image is transferred onto a recording material P, as a sheet conveyed with predetermined timing, in a transfer nip formed between the photosensitive drum 1 and a transfer roller 5. Here, a leading end of the recording material P is detected by a top sensor 8 and timing is set so that an image forming position of the toner image on the photosensitive drum 1 coincides with a writing position of the leading end of the recording material P. The recording material P conveyed with predetermined timing is nip-conveyed under certain pressure in the transfer nip and is conveyed to a fixing device 6 as the image heating apparatus. In the fixing device 6, the toner image on the recording material P is fixed as a permanent image. The recording material P coming out of the fixing device 6 is guided by a discharging guide and is discharged out of the image forming apparatus. On the other hand, transfer residual toner remaining on the photosensitive drum 1 is removed from the surface of the photosensitive drum 1 by a cleaning device 7. Further, a discharge sensor 9 is provided in the fixing device 6. The discharge sensor 9 detects paper jam when the recording material P causes the paper jam between the top sensor 8 and the discharge sensor 9.

### (Fixing Device)

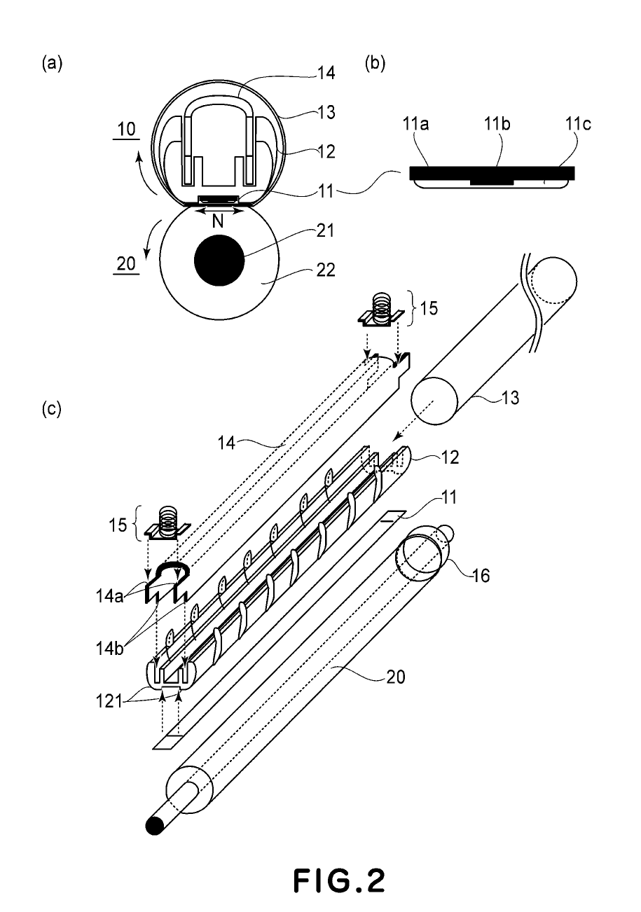

FIGS. 2(a) to 2(c) show a schematic structure of the fixing device 6. The fixing device 6 is basically a surf-heating type fixing device including a fixing assembly 10 and a pressing roller 20, as a pressing member, which press-contact each other to form a fixing nip N. The fixing device 6 nip-conveys the recording material P in the fixing nip N and at that time the toner image is melted and fixed on the recording material P under heat and pressure. FIG. 2(a) is a sectional view of the fixing device 6, and FIG. 2(c) is an exploded perspective view of the fixing device 6. As shown in FIGS. 2(a) and 2(c), the fixing assembly 10 principally includes a heater 11, a supporting member 12, a flexible sleeve 13 and a metal stay 14.

### (Heater)

FIG. 2(b) is a sectional view of the heater 11. As shown in FIG. 2(b), the heater 11 heats the fixing nip N in contact with the inner surface of the sleeve 13. On the surface of a ceramic substrate 11a constituting the heater 11, an energization heat generating resistance layer 11b is formed. The ceramic substrate 11a is a plate-like insulative substrate of alumina, aluminum nitride, or the like having low thermal capacity. The energization heat generating resistance layer 11b is formed of Ag/Pd (silver/palladium), RuO₂, Ta₂N, or the like in a thickness of about 10 μm and a width of about 1 to 5 μm along a longitudinal direction of the ceramic substrate 11a (i.e., a recording material (sheet) width direction) by screen printing or the like. At the surface of the heater 11 contacting the sleeve 13, a protective layer 11c for protecting the energization heat generating resistance layer 11b is provided within the range not impairing heat efficiency. The thickness of the protective layer 11c may desirably be sufficiently small to the extent that a surface smoothness is improved. The protective layer 11c is formed by coating with glass, fluorine-containing resin, or the like.

### (Supporting Member)

The supporting member 12 supports the heater 11. Further, the supporting member 12 guides the rotating sleeve 13. The supporting member 12 is formed of heat-resistant resin material such as a liquid crystalline polymer, phenolic resin, PPS (polyphenylene sulfide), or PEEK (polyether ether ketone). When the supporting member 12 has lower thermal conductivity, better heat conduction to the pressing roller 20 can be realized, so that the supporting member 12 may also contain filler such as glass balloon or silica balloon in the resin layer. The supporting member 11 is provided with two projected jaws 121 extending in the longitudinal direction, i.e., the recording material width direction in upstream and downstream areas adjacent to the heater 11 with respect to the rotational direction of the sleeve 13. That is, between the two jaws 121, the heater 11 is disposed. The jaws provide an angle between the fixing nip N portion of the sleeve 13 and another portion of the sleeve 13, so that a parting property of the recording material P from the sleeve 13 is improved. Further, the jaws 121 conduct the heat to the pressing roller 20 by a pre-heat effect that the jaws 121 are warmed earlier than the pressing roller 20 and the like. Incidentally, the jaws 121 are provided on the supporting member 12 but the supporting member 12 may also be not provided with the jaws 121.

Each of the jaws 121 is provided with a recess-projection shape portion 12a described later. By the provision of the recess-projection shape portion 12a, a diffusion property of the lubricant such as the grease is improved. Further, even when the jaws 121 are not provided, the recess-projection shape portion may also be provided in each of the upstream and downstream areas, adjacent to the heater 11 with respect to the rotational direction of the sleeve 13, corresponding to the jaws 121 of the supporting member 12. Further, the recess-projection shape portion may also be provided in either one of the upstream and downstream areas adjacent to the heater 11 with respect to the rotational direction of the sleeve 13.

### (Sleeve)

The sleeve 13 is flexible and cylindrical and includes the heater 11 and the supporting member 12, and is rotated around the heater 11 and the supporting member 12. The sleeve 13 may preferably be a heat-resistant film of 200 μm or less in total thickness in order to enable quick start. The sleeve 13 includes a base layer 13a of the heat-resistant resin material such as polyimide, polyamideimide or PEEK. In the base layer 13a, in order to improve the thermal conductivity, high heat-conductive powder of BN, alumina, Al or the like may be mixed. Further, the sleeve 13 which has a sufficient strength for constituting the fixing device 6 having a long lifetime and which is excellent in durability requires the total thickness of 20 μm or more. Therefore, an optimum total thickness of the sleeve 13 is 20 μm or more and 200 μm or less.

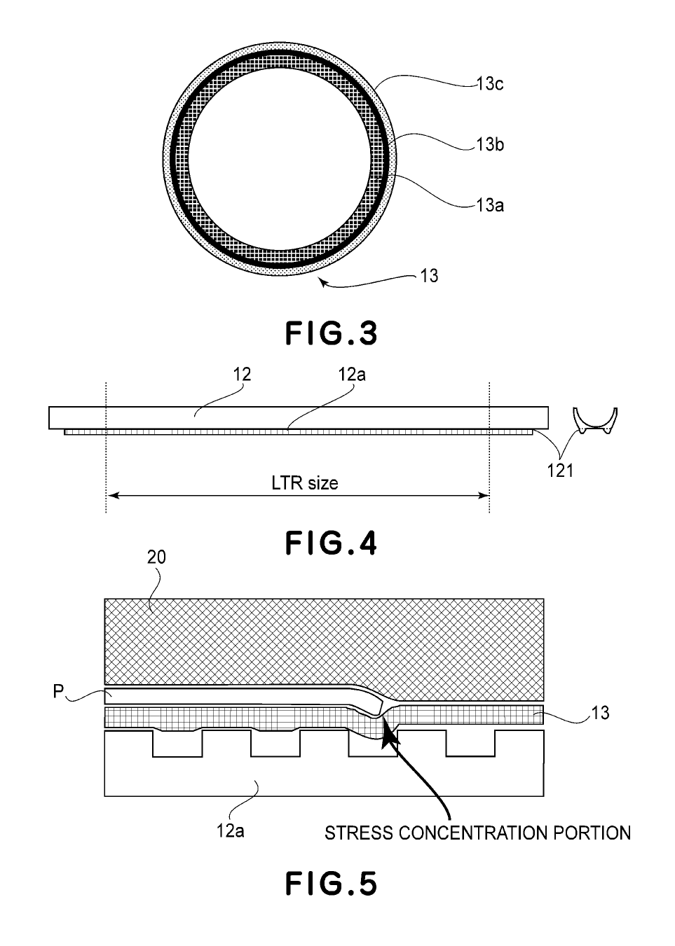

Further, in order to ensure an offset preventing property and a parting property of the recording material, as the surface layer of the sleeve 13, a parting layer 13c is formed by coating an underlying layer with the heat-resistant resin material, having a good parting property, including the fluorine-containing resin such as PTFE (polytetrafluoroethylene), PFA (tetrafluoroethylene-perfluoroalkylvinylether-copolymer), FEP (tetrafluoroethylene-hexafluoropropylene-copolymer), ETFE (ethylene-tetrafluoroethylene-copolymer), CTFE (polychlorotrifluoroethylene), PVDF (polyvinylidene fluoride), or the like and including a silicone resin and the like. These resin materials may be used singly or in mixture of two or more species. The parting layer 13c may be coated by a dipping method in which an outer surface of the sleeve 13 is etched and then the sleeve 13 is dipped or subjected to power spray coating or by a method in which the surface of the sleeve 13 is coated with a resin material formed in a tube-like shape. It is also possible to use a method in which the outer surface of the sleeve 13 is subjected to blasting and then the primer layer 13b is first applied and thereafter the parting layer 13c is coated on the parting layer 13c. The sleeve 13 in this embodiment is prepared, as shown in FIG. 3, by applying the electroconductive primer layer 13b onto the base layer 13a which is the high heat-resistant resin film and then by coating the primer layer 13b with the parting layer 13c of PFA.

### (Metal Stay)

The metal stay 14 contacts the supporting member 12 and suppress bending and twisting of the fixing assembly 10 as a whole. The metal stay 14 receives an urging force from a coil spring 15 and urges the supporting member 12 toward the pressing roller 20.

### (Pressing Roller)

The pressing roller 20 presses the sleeve 13 against the heater 11 to form the fixing nip N between itself and the sleeve 13. The pressing roller 20 is an elastic roller prepared by forming an elastic layer 22 on another surface of the metal core 21. The metal core 21 is formed of SUS (steel use stainless), SUM (steel use machineability), Al, or the like. As the elastic layer 22, an elastic solid rubber layer or the like formed with heat resistant rubber such as silicone rubber or fluorine-containing rubber is used. It is also possible to use an elastic sponge rubber or the like formed by expanding (foaming) the silicone rubber in order to provide a heat insulating effect or to use an elastic foamed rubber layer or the like enhanced in heat insulating effect by dispersing a hollow filler (microballoon or the like) in the silicone rubber layer to form an aerated portion in a cured product. Incidentally, on the elastic layer 22, a parting layer of PFA, PTFE, or the like may also be formed.

### (Driving and Control Method of Fixing Device)

As shown in FIG. 2(c), the metal stay 14 is projected at its end portions with respect to its longitudinal direction (recording material width direction). At the longitudinal end portions of the metal stay 14, spring-receiving portions 14a are provided so as to be urged by a coil spring 15 through a spring-receiving member. A load on the stay 14 by the coil spring 15 is uniformly transmitted to the supporting member 12 through stay feet 14b over the longitudinal direction of the supporting member 12. As a result, the fixing assembly 10 is urged against elasticity of the pressing roller 20. Further, by the urging force (pressure) of the supporting member 21, the sleeve 13 is bent by being nipped between the heater 11 and the pressing roller 20, thus being placed in a state in which the sleeve intimately contacts the heating surface of the heater 11.

The pressing roller 20 receives a driving force, for being rotated in a direction of an arrow indicated in FIG. 2(a), by an unshown gear provided at the end portion of the core metal 21. The driving force is transmitted from an unshown motor in accordance with an instruction from an unshown CPU which controls the control means. By the rotational drive of the pressing roller 20, the sleeve 13 is rotated by a frictional force between itself and the pressing roller 20. Between the inner surface of the sleeve 13 and a sliding portion between the heater 11 and the supporting member 12, the lubricant such as heat-resistance grease of a fluorine-containing type or a silicone type is interposed. By the lubricant, friction resistance can be lowered, so that the sleeve 13 is rotatable smoothly.

Further, a temperature of the heater 11 is appropriately controlled by the CPU by determining duty, wave number, and the like of the voltage to be applied to the energization heat generating resistance layer 11b depending on a signal of a temperature detecting element such as a thermistor (not shown) or the like provided on a rear surface of the ceramic substrate 11a. By this temperature control of the heater 11, the temperature in the fixing nip N can be kept at a desired (setting) fixing temperature. Then, the recording material carrying thereon the unfixed toner image is appropriately fed with predetermined timing and is conveyed into the fixing nip N in which the toner image is heat-fixed on the recording material.

### (Recess-Projection Shape of Supporting Member)

In a conventional embodiment, as shown in FIG. 4, the jaws 121 of the supporting member 12 is provided with the recess-projection shape 12a in a substantially whole area thereof with respect to the longitudinal direction (recording material width direction). By providing the recess-projection shape 12a, the diffusion property of the lubricant such as grease is improved. In this case, a mechanism that the scraping and the separation of the parting layer 13c of the sleeve 13 is accelerated by stress concentration caused at the recording material end portion with respect to the recording material width direction will be described with reference to FIG. 5. FIG. 5 shows an area in which the sleeve is sandwiched between the supporting member and the pressing roller at least on an upstream side and a downstream side of a heater supporting position of said supporting member with respect to the rotational direction of the sleeve.

In general, the stress concentration occurs due to the presence of recesses and projections or in a boundary area defined by the presence and absence of paper itself, thus leading to a disadvantageous state with respect to the durability of the member such as the sleeve 13. Further, as shown in FIG. 5, when the recess-projection shape 12a is present at the position in which the recording material end portion with respect to the recording material width direction is conveyed, the recording material end portion is bent toward a recessed portion to cause considerable stress concentration, so that the load on the sleeve 13 is very large. As a result, in the conventional embodiment as shown in FIG. 4, the scraping and the separation of the parting layer 13c of the sleeve 13 have been caused early.

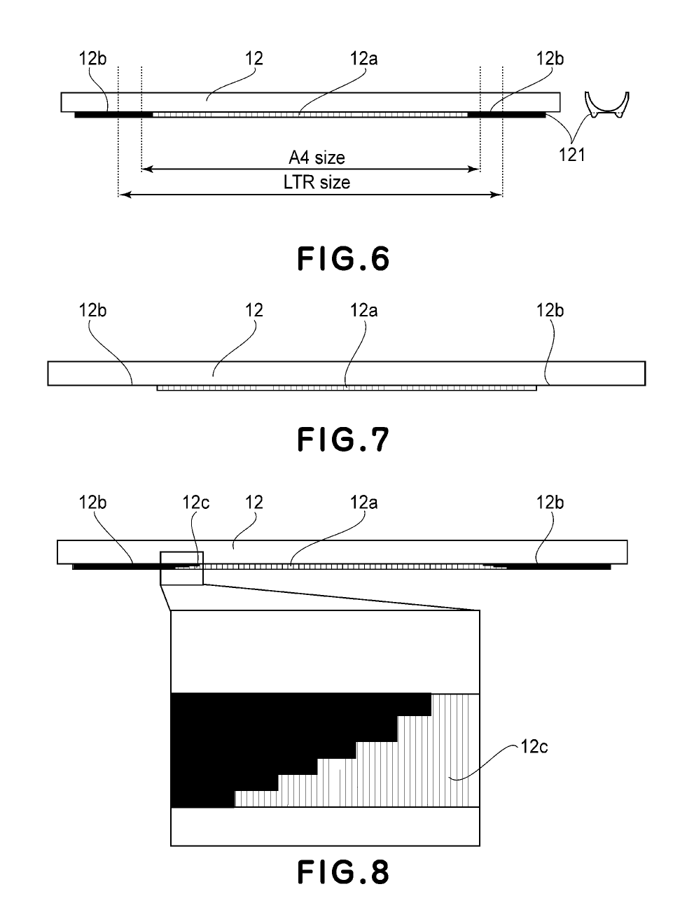

On the other hand, in this embodiment, the feature of the supporting member 12 is illustrated in FIG. 6. In this embodiment, the recess-projection shape 12a for improving the diffusion property of the lubricant at the jaws 121 of the supporting member 12 is not formed in the whole area with respect to the longitudinal direction (recording material width direction) but is formed only in an area narrower than a maximum width of the recording material (maximum sheet width of the recording material which can be conveyed in the area). Specifically, when the maximum width of the recording material is 216 mm of letter (“LTR”)-sized paper, a length of the area in which the recess-projection shape 12a is formed is 200 mm. Incidentally, in the conventional embodiment shown in FIG. 4, the length of the recess-projection shape 12a forming area is 232 mm.

Here, the recess-projection shape 12a is provided so that its projected surface is flash with a flat surface of an end portion area 12b, in which the recess-projection shape is not formed, provided on both sides of the recess-projection shape 12a with respect to the recording material width direction. As a result, a plurality of recessed portions is present between the end portion areas 12b. For this reason, projected portions of the recess-projection shape 12a are leveled with the flat surface of the end portion areas 12b. As a result, in this embodiment, at a position in which the recording material end portion with respect to the recording material width direction passes. the recess-projection shape 12a is not present but the flat end portion area 12b is present. Therefore, at the recording material end portion passing position, stress concentration is not caused due to the presence of the flat end portion area 12b, so that a load at this position is alleviated. Accordingly, the scraping and the separation of the parting layer 13c of the sleeve 13 are not readily caused, so that the durability of the sleeve 13 is improved. Thus, there is the area of the supporting member in which the sleeve is sandwiched between the supporting member and the pressing roller at least on the upstream side and the downstream side of the heater supporting position of the supporting member with respect to the rotational direction of the sleeve. At the surface of the supporting member in the area, the plurality of recessed portions for permitting passing of the lubricant is provided. The recessed portions are provided only in the area in which a sheet, with a predetermined in maximum width, available in the apparatus passes. Particularly, the height of the surface of the supporting member on which the maximum width sheet end portion passes is made substantially equal to the height of the projected portions in the area in which the recessed portions are provided, so that the scraping of the sleeve surface by the sheet end portion can be suppressed.

By using such a structure, it is possible to improve the durability of the sleeve 13 by diffusing the lubricant satisfactorily to alleviate the load on the surface layer of the sleeve 13.

### (Verification)

In order to confirm the effect of the present invention, verification was made by an experiment. The supporting member 12 in this embodiment is provided with the recess-projection shape 12a in the area of 200 mm with respect to the longitudinal direction as shown in FIG. 6. Further, for comparison, the supporting member 12 of the conventional embodiment provided with the recess-projection shape 12a in the substantially entire longitudinal area (232 mm) as shown in FIG. 4 was used. Further, as Comparative Embodiment, a comparative supporting member 12 provided with the recess-projection shape 12a and the end portion area 12b which had a surface height lower than that of the projected portions of the recess-projection shape 12a was prepared.

By using these supporting members, in an environment of room temperature of 23° C. and a relative humidity of 50% RH, the LTR-sized paper (paper width=216 mm) was continuously passed through the fixing device at a print speed of 26 ppm, and a degree of the scraping and the separation of the parting layer of the sleeve was checked. The controlled temperature was 200° C. A result of the experiment is shown in Table 1.

TABLE 1

| EMB. NO. | 50 × 10³ | 75 × 10³ | 100 × 10³ | 125 × 10³ |
|---|---|---|---|---|
| EMB. 1 | A | A | A | A |
| CONV. EMB. | A | B | C | C |
| COMP. EMB. | B | C | C | C |

In Table 1, “50×10³”, “75×10³”, “100×10³” and “125×10³” represents the number of sheets passed through the fixing device in the experiment. Further, “A” represents that the parting layer as the sleeve surface layer was not scraped or abraded. “B” represents that the parting layer was scraped and the primer layer was exposed. “C” represents that not only the parting layer but also the primer layer were scraped and the base layer was damaged.

Generally, when the parting layer is broken, the parting property is lowered and the charging state of the sleeve is disturbed, so that an image problem such as offset occurs. Also in this experiment, in the case where the scraping and the separation occurred in the base layer, the offset occurred due to the disturbed charging state.

As shown in Table 1, in this embodiment (EMB. 1), the occurrence of the scraping and the separation was effectively prevented, so that the durability of the sleeve was able to be improved. Also with respect to an image quality and a conveying performance, in this embodiment, the recess-projection shape 12a for promoting the diffusion of the lubricant was formed in 86% of the area with respect to the longitudinal direction, so that non-uniformity of the lubricant did not occur and a problem due to the non-uniformity of the lubricant was not caused.

Further, in this embodiment, a force is applied uniformly to the sleeve by the surfaces of the projected portions in the area in which the recess-projection shape 12a is formed and by the entire flat surface in the end portion area 12b in which the recess-projection shape 12a is not formed. On the other hand, as in Comparative Embodiment (COMP.EMB.) shown in FIG. 7, in the case where there are stepped portions between the projected portion of the recess-projection shape 12a and the surface in the end portion area 12b in which the recess-projection shape 12a is not formed, the force received by the sleeve is inevitably localized. In Comparative Embodiment, the projected portions of the recess-projection shape 12a are higher than the surface of the area in which the recess-projection shape 12a is not formed. However, on the other hand, although not illustrated, also in the case where the projected portions of the recess-projection shape 12a are lower than the surface of the area in which the recess-projection shape 12a is not formed, a similar problem occurs. Thus, when the stepped portion is present, the load exerted on the sleeve concentrates especially in a boundary area of the stepped portion, so that damage of the sleeve such as the scraping or the separation is caused to occur.

The maximum width of the recording material which can be outputted by the image forming apparatus used in this experiment is 216 mm which is the width of the LTR-sized paper but is changed to, e.g., 210 mm (A4-sized paper) depending on a region in which the recording material is used. Therefore, under the same condition, the experiment was also conducted with respect to the A4-sized paper (paper width=210 mm). A result thereof is shown in Table 2.

TABLE 2

| EMB. NO. | 50 × 10³ | 75 × 10³ | 100 × 10³ | 125 × 10³ |
|---|---|---|---|---|
| EMB. 1 | A | A | B | B |
| CONV. EMB. | A | B | C | C |

In this embodiment, also with respect to the A4-sized paper, the recess-projection shape 12a is not present at the position in which the recording material end portion with respect to the recording material width direction passes. Therefore, also with respect to the A4-sized paper, the effect of the present invention was able to be confirmed.

From the above results of the experiment, it was confirmed that the scraping and the separation of the parting layer 13c of the sleeve 13 are not readily caused and thus the durability of the sleeve 13 is improved.

### Embodiment 2

### (Recess-Projection Shape of Supporting Member)

The supporting member 12 in this embodiment is shown in FIG. 8. The constitution except the supporting member 12 in this embodiment is identical to that in Embodiment 1. Therefore, only the supporting member 12 will be described and other portions will be omitted from description.

The load on the sleeve 13 is increased by the stress concentration but a degree of the stress concentration is also generally increased particularly with a degree of a difference in height of the projected portions and the projected portions of the recess-projection shape 12a. In the area of the recess-projection shape 12a close to a boundary line thereof with the end portion area 12b, the recessed portion and the projected portion are inevitably present and when the large number of sheets of the recording material are successively conveyed at the position in which the recording material end portion with respect to the recording material width direction passes, the scraping and the separation of the parting layer 13c of the sleeve 13 can occur. Specifically, the case of 16K-sized paper (paper width=195 mm) or the like used in a region of a part of China or the like corresponds to that case. In this case, when the recess-projection shape 12a is formed in the area of 200 mm with respect to the longitudinal direction similarly as in Embodiment 1, the position in which the recording material end portion of 16K-sized paper with respect to the recording material width direction passes is included in the area of the recess-projection shape 12a, so that the load on the sleeve 13 is increased.

In this embodiment, in order to prevent the scraping and the separation of the parting layer 13c of the sleeve 13 with respect to the recording material having the paper width within the maximum width, the constitution shown in FIG. 8 is employed. In this embodiment, the supporting member 12 includes the recess-projection shape 12a having the width narrower than the maximum width of the recording material and includes the end portion area 12b and a stepped recess-projection shape 12c located between the recess-projection shape 12a and the end portion area 12b. The stepped recess-projection shape 12c is formed so that a depth of recessed portions thereof is gradually changed toward the end portion area 12b. Specifically, the depth of the recessed portions of the stepped recess-projection shape 12c is smaller with a decreasing distance between the stepped recess-projection shape 12c and the end portion area 12b in which the recess-projection shape is not formed. That is, the depth of the recessed portions is stepwisely decreased as the recessed portions approach the end portion area 12b. Incidentally, a method of gradually decreasing the depth of the recessed portions is not limited to that in this embodiment but may also be another method. When the depth of the recessed portion of the recess-projection shape 12a is small, the difference in height (depth) between the recessed portions and the projected portions is also small, so that the stress concentration is suppressed. As a result, even in the case where the recording material end portion with respect to the recording material width direction passes through the area of the stepped recess-projection shape 12c close to the boundary line between the stepped recess-projection shape 12c and the end portion area 12b, the stress concentration is suppressed by the decreased depth of the recessed portions, so that the load on the sleeve 13 can be reduced. Therefore, the scraping and the separation of the parting layer 13c of the sleeve 13 are not readily caused and thus the durability of the sleeve 13 is improved. That is, according to this embodiment, it is possible to improve the durability of the sleeve 13 by diffusing the lubricant satisfactorily to alleviate the load on the surface layer of the sleeve 13.

### (Verification)

In order to confirm the effect of the present invention, verification was made by an experiment. The supporting member 12 in this embodiment was provided with the recess-projection shape 12a including recessed portions having the same depth in the area of 170 mm with respect to the longitudinal direction. Further, between the recess-projection shape 12a equal in recessed portion depth and the end portion area 12b, the stepped recess-projection shape 12c including the recessed portions gradually decreased in depth toward the end portion area 12b was formed in an area of 15 mm on each of longitudinal end sides. Incidentally, the projected portions of the recess-projection shape 12a and the height projected portion of the stepped recess-projection shape 12c have the same height as the flat surface of the end portion area 12b. Further, for comparison, the supporting member 12 of the conventional embodiment provided with the recess-projection shape 12a in the substantially entire longitudinal area (232 mm) as shown in FIG. 4 was used.

By using these supporting members, in an environment of room temperature of 23° C. and a relative humidity of 50% RH, the 16K-sized paper (paper width=195 mm) was continuously passed through the fixing device at a print speed of 13 ppm, and a degree of the scraping and the separation of the parting layer of the sleeve was checked. The controlled temperature was 200° C. A result of the experiment is shown in Table 3.

TABLE 3

| EMB. NO. | 50 × 10³ | 75 × 10³ | 100 × 10³ |
|---|---|---|---|
| EMB. 2 | A | B | B |
| CONV. EMB. | A | B | C |

In this embodiment, at the recording material end portion with respect to the width direction of the recording material, i.e., the 16K-sized paper, the recessed portions and the projected portions of the stepped recess-projection shape 12c are present but the difference in height (depth) between the recessed portions and the projected portions is small and therefore the stress concentration can be suppressed to some extent. As a result, although the degree of improvement in durability in this embodiment is smaller than those in the cases of the LTR-sized paper and the A4-sized paper, it was confirmed that the scraping and the separation of the parting layer 13c of the sleeve 13 were not readily caused and thus the durability of the sleeve 13 was improved also with respect to the recording material having the paper width other than the maximum width.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 250167/2009 filed Oct. 30, 2009, which is hereby incorporated by reference.

What is claimed is:

1. An image heating apparatus comprising:
a flexible sleeve;
a heater contacted to an inner circumferential surface of said sleeve;
a pressing roller for forming a nip, between itself and said sleeve contacted by said heater, in which a recording material is to be heated; and
a supporting member for supporting said heater, said supporting member being disposed inside said heater and having an area in which said sleeve is sandwiched between said supporting member and said pressing roller at least on an upstream side and a downstream side of a heater supporting position of said supporting member with respect to a rotational direction of said sleeve,
wherein said supporting member is provided, at its surface in the area, with a plurality of recessed portions for permitting passage of a lubricant, and
wherein the recessed portions are provided only in an area in which a predetermined maximum width sheet available in said image heating apparatus is passable.

2. An apparatus according to claim 1, wherein a depth of the recessed portions is smaller at a position closer to an end of said supporting member with respect to a longitudinal direction of said supporting member.
